(19) United States
(12) Patent Application Publication
(10) Pub. No.: US 2013/0198338 A1
(43) Pub. Date: Aug. 1, 2013

(54) ENHANCING PERCEIVED PERFORMANCES OF COMPUTER APPLICATIONS

(71) Applicants: Carmit Pinto, Tzofim (IL); Eyal Sinai, Kfar Saba (IL)

(72) Inventors: Carmit Pinto, Tzofim (IL); Eyal Sinai, Kfar Saba (IL)

(21) Appl. No.: 13/363,085

(22) Filed: Jan. 31, 2012

(51) Int. Cl. G06F 15/16

(52) U.S. Cl. 709/219

(57) ABSTRACT

Methods, computer-readable media, and computer systems for enhancing perceived performances of computer applications. In response to a first request for a resource received at an application executing on a client computer system, a version of the resource is provided. A current version of the resource is remotely stored on a server computer system that is connected to the client computer system over a network. A past version of the resource previously is locally stored on the client computer system from which the first request is transmitted. The application determines that the version that was provided was the past version, and, in response, transmits a second request to the server system to identify differences between the current version and the past version.

### TECHNICAL FIELD

The present disclosure relates to software, computer systems, and computer- implemented methods that provide resources.

### BACKGROUND

Computer software applications can be implemented as computer software instructions executable by data processing apparatus of computer systems to perform operations. The computer systems that execute certain applications can be client computer systems that are connected to remotely located server computer systems through one or more wired or wireless networks, such as the Internet. Such an application can cause a user interface (for example, an Internet browser window) to be displayed in a display device connected to the client computer system. Through the user interface, a user of the application can provide input to perform operations. The application can display output in response to the input, for example, in the user interface. For example, in response to receiving the input, the application can cause the client computer system to transmit a request for a resource or resources to a server computer system to which the client computer system is connected. When the client computer system receives the resources from the server computer system, the application can cause the client computer system to display the resources in the user interface.

A speed with which the client computer system transmits the request for the resources to the server computer system and receives the resources from the server computer system can depend, in part, on a speed of the network connection between the client computer system and the server computer system. In some situations, the server application can cause a copy of resources received from the server computer system to be stored on a computer-readable storage medium that is local to the client computer system (“client cache” or “browser cache”) such that, to satisfy future requests for the same resources, the application can retrieve the copy that is locally stored on the computer-readable storage medium rather than cause the client computer system to transmit a new request over the network for the resources to the server computer system. However, in such situations, modifications that may have been made to the resources stored on the server computer system since the server computer system previously provided the resources to the client computer system may not be reflected in the copy retrieved from the client cache.

### SUMMARY

The present disclosure involves systems, software, and computer-implemented methods to enhance perceived performances of computer applications.

In general, one innovative aspect of the subject matter described here can be implemented as a computer-implemented method performed by data processing apparatus. A first request for a resource received at a client computer system is transmitted. A version of the resource received in response to transmitting the first request is provided. A first version of the resource is remotely stored on a server computer system that is connected to the client computer system over a network. The server computer system is located remotely from the client computer system. A second version of the resource is locally stored on a computer-readable storage medium that is connected to and is local to the client computer system from which the first request is transmitted. It is determined that the version of the resource that was provided was the second version of the resource locally stored on the computer-readable storage medium. A second request is transmitted to the server system to identify differences between the first version and the second version, in response to determining that the version of the resource that was provided was the second version.

This, and other aspects, can include one or more of the following features. Transmitting the first request can include a first identifier in the first request, and transmitting the first identifier with the first request to the server computer system. Including the first identifier in the first request can include the first identifier in a header of the first request. A response from the server computer system can be received in response to transmitting the first request. The server computer system can include a second identifier in the response. The second identifier can be retrieved and compared with the first identifier. It can be determined that the version of the resource that was provided was the second version based on determining that the first identifier does not match the second identifier. Transmitting the second request to the server system to identify the differences between the first version and the second version can include a new identifier in the second request, wherein the server system includes the new identifier in a new response to the second request, the new response including the first version of the resource, receiving the new response from the server computer system, and determining that the new identifier included in the second request matches the new identifier in the new response. Including the new identifier in the second request can include appending the new identifier to a Uniform Resource Locator (URL) included in the second request, wherein the URL refers to the version of the resource. The first version of the resource and the second version of the resource can be compared, and, in response to determining that differences exist between the first version of the resource and the second version of the resource, the provided version can be updated based on the differences. It can be determined that the version of the resource that was provided was the first version based on determining that the first identifier matches the second identifier. In response to determining that the first identifier matches the second identifier, the second request may not be transmitted to the server computer system. The first identifier can be generated in response to receiving the first request, and included in the first request. The first identifier can be a timestamp at which the first request was received. The second version of the resource locally stored on the computer-readable storage medium can be invalidated in response to receiving an instruction from the server computer system to invalidate the second version. Receiving the instruction from the server computer system to invalidate the second version can include causing requests for the version of the resource to be transmitted to the server computer system instead of client computer system. The second version of the resource is locally stored on the computer-readable storage medium at a time prior to the first request for the resource being transmitted. The first version can be a current version of the resource and the second version can be a previous version of the resource previously received from the server computer system. Transmitting the first request for resource can include transmitting the first request for resource to the server computer system.

Another innovative aspect of the subject matter described here can be implemented as a non-transitory computer-readable medium tangibly encoding computer program instructions executable by data processing apparatus to perform operations described here. A further innovative aspect of the subject matter described here can be implemented as a system comprising data processing apparatus and a non-transitory computer-readable medium tangibly encoding computer program instructions executable by the data processing apparatus to perform operations described here.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 illustrates an example environment for implementing various features of client computer systems connected to server computer systems through networks.

FIG. 2 illustrates an example of a server computer system connected to a client computer system that implements a computer software application.

FIG. 3 illustrates example operations in which a resource received from a server is not locally stored on a client cache.

FIG. 4 illustrates example operations in which a resource is locally stored on a client cache for a specified duration.

FIGS. 5A and 5B illustrate example operations in which a locally stored resource is invalidated in response to instructions from a server.

FIGS. 6A and 6B illustrates example operations in which a determination of whether a resource was retrieved locally or remotely is made.

Like reference numbers and designations in the various drawings indicate like elements.

### DETAILED DESCRIPTION

This disclosure generally describes computer systems, software, and computer-implemented methods to enhance perceived performances of web applications (Internet applications). In addition, this disclosure describes computer-implemented methods to present most recent versions of resource on a web browser (Internet browser), for example, by dynamically updating a past version of resource that has been presented on the web browser with differences between a current version stored on a server computer system and the past version. Web or client applications are implemented as computer software instructions executed by web browsers which run on client computer systems. A web browser (“client”) which runs on a client computer system, for example, a desktop computer, a laptop computer, a tablet computer, and the like, can interact with a server computer system (“server”) through one or more wired or wireless networks, which the client computer system is connected to, such as the Internet. The server can include one or more computer systems including data processing apparatus that can execute computer software instructions stored on a computer-readable medium and one or more computer-readable storage devices that store resources. A web or client application (“application”) can cause the web browser to present data including resources. In situations in which the resources are remotely stored on the server, the application can cause the web browser to transmit a request for the resources to the server and to receive the resources from the server.

By implementing the techniques described here, an experience of a user interacting with an application can be enhanced because the user can perceive an enhanced performance of the application when the application retrieves locally stored versions of resource requested by the user shortly after the user requests the resource. Further, as the user is interacting with the locally stored versions of the resource, a remotely stored current version of the resource can be received from the server, and the presented version of the resource can be automatically updated based on differences, if any, between the locally stored and remotely stored versions. In addition, in some situations, the user can be notified that the version presented is a previous version and that a request has been transmitted for the current version so that the user is aware that an updated version of the resource will be presented. The techniques described here can be implemented in web applications which run on various web browsers.

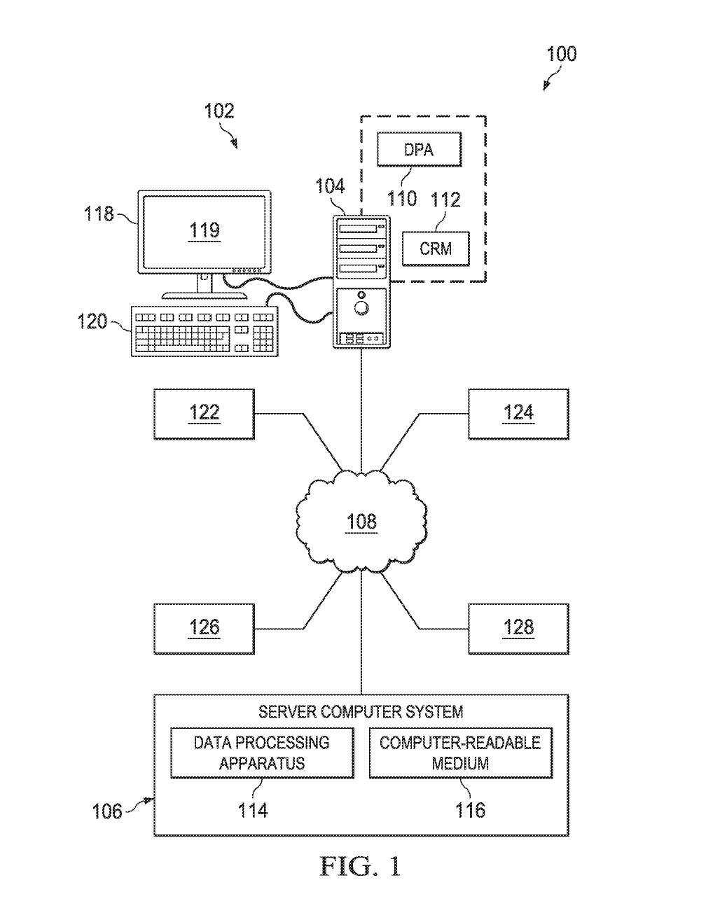

FIG. 1 illustrates an example environment 100 for implementing various features of client computer systems connected to server computer systems through networks. A client computer system 102, including a client computer 104, is connected to a server computer system 106 over one or more wired or wireless networks 108, for example, the Internet. The client computer 104 includes data processing apparatus 110 configured to execute computer software instructions stored in a computer-readable medium 112 to perform operations described here. The client computer 104 is connected to an output device such as a display device 118, for example, a computer monitor, and to one or more input devices 120, for example, a keyboard, a mouse, a touch screen, and the like. The client computer 104 can receive input to perform operations through the input devices 120, and provide output in response to the received input. For example, the client computer 104 can display the output in the display device 118. The client computer 102 is running a web browser 119 which executes a web application. The web application interacts with the server and displays a user interface (UI) including data and resources from the server on the web browse 119.

The server computer system 106 can include a data processing apparatus 114 that can execute computer software instructions stored on a computer-readable medium 116 to perform operations. For example, the server 106 can receive requests for resources over the network 108, and can provide responses to the requests. The server 106 can include or be connected to (or both) computer-storage devices (not shown) that can store the requested resources. One or more proxy servers or routers or both (not shown) can be included between clients and the server 106 such that requests for resources from the clients can be routed through the proxy servers. Further, the server 106 can be implemented as multiple computer systems, each of which can include respective data processing apparatus that can execute all or portions of the computer software instructions stored in the computer-readable medium 116.

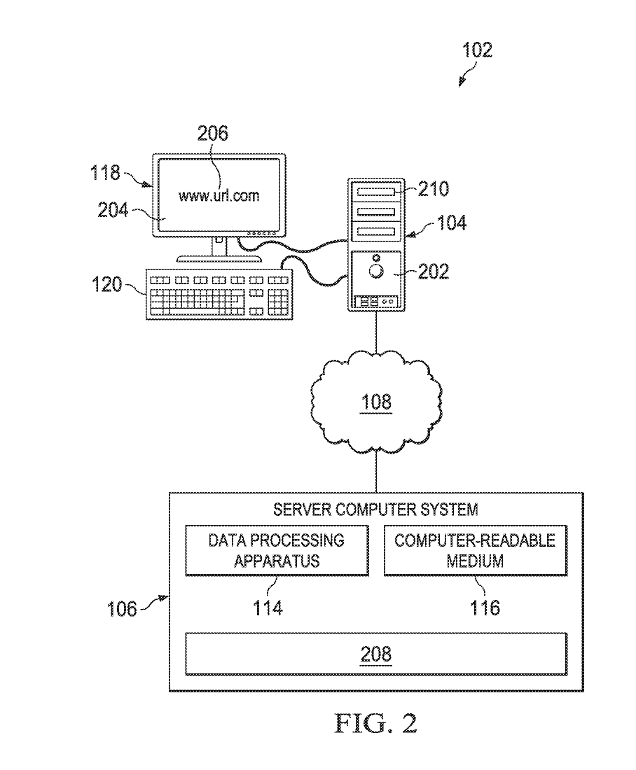

The environment 100 can include multiple client computer systems (for example, client 122, client 124, and the like) similar to client 102, and multiple servers (for example, server 126, server 128) similar to server 106 that are connected to each other through the one or more wired or wireless networks 108. For example, client 122 can be a laptop computer, client 124 can be a tablet computer, and another client (not shown) can be a mobile device. The techniques described below, and particularly with reference to FIG. 2, are described below as being implemented using web browser 119 which may run on any of the clients 102, 122, or 124. Similarly, the techniques described below with reference to server 106 can be implemented using any server, for example, server 126, server 128, and the like, or using combinations of servers.

FIG. 2 illustrates an example of a server 106 connected to a client 102 that implements an application 202. The application 202 can be implemented using the client 102, for example, by installing the application 202 on the client computer 104. In some implementations, the application 202 can receive requests for resources from a user of the client 102, cause the client 102 to transmit requests for the resources, for example, to the server 106, and cause the client 102 to display resources received in response to the requests. For example, the application 202 can be an Internet application that can provide resources on the Internet to a user of the client 102. A performance of the application 202 can be measured, in part, based on a period from when a user provides a request for a resource to the application 202 to when the application 202 provides the resource in response to the request.

In some implementations, when the application 202 is executed by the client 102, the application 202 can cause the client 102 to display a user interface 204, for example, an Internet browser, in the display device 118. Within the user interface 204, the application 202 can display multiple selectable objects that represent resources. For example, the user interface 204 can display a Uniform Resource Locator (URL) 206, a first thumbnail representing an image, a second thumbnail representing a video, text, and the like. Each resource can be remotely stored on the server 106 such that, when the user launches the application 202, for example, by selecting an application-related icon displayed in the display device 118, the application 202 transmits multiple requests for the resources to the server 106. Each request corresponds to one of the resources represented by an object displayed in the user interface 204. Depending, in part, on a speed of the network 108, a response to each request may take a few milliseconds, for example, 10 to 15 ms. Responses to requests for all the resources represented by all the objects displayed in the user interface 204 may take several seconds.

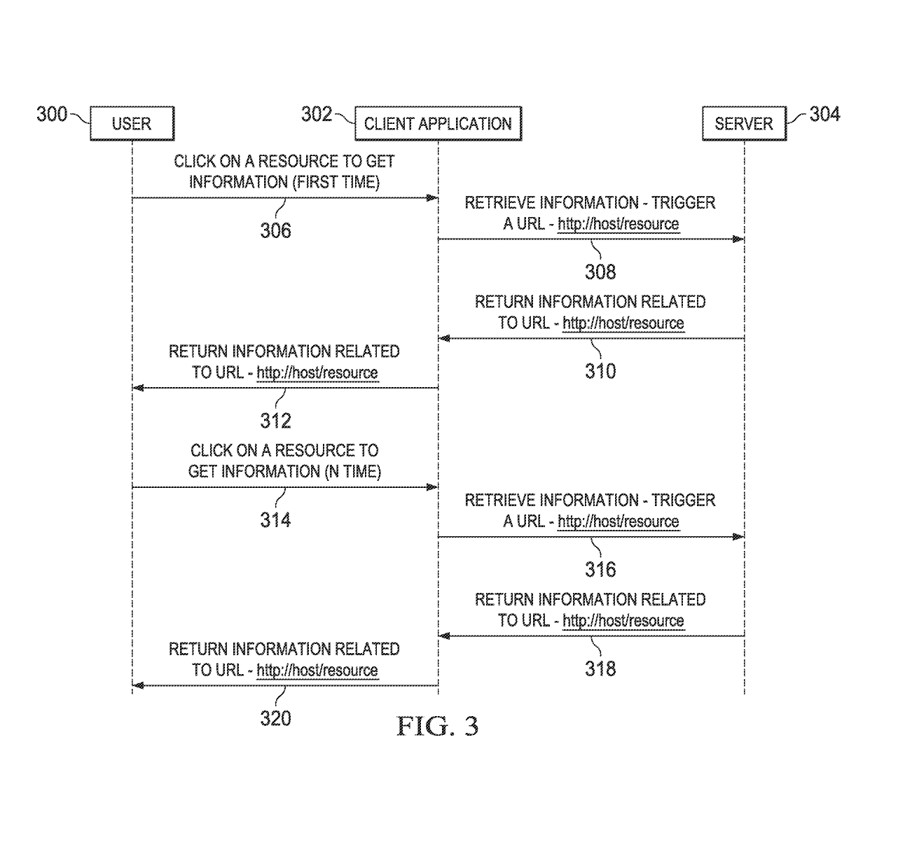

FIG. 3 illustrates example operations in which resource received from a server is not locally stored on a web browser (“client”) cache. Because a provider of the resources (for example, a publisher of an Internet web page) can make modifications to the remotely stored resources, a version of a resource stored on the server can be a current version. As described above, an application can display a selectable object, for example, a URL, in a user interface. A user 300 can click on a resource to get information for a first time at 306. For example, the user 300 can select the selectable object and consequently select the resource to get information. The selection at 306 can represent a first time that the user 300 selects the resource. The application 302 can retrieve information by triggering a URL (for example, http://host/resource) at 308. For example, in response, the application 302, which is executed by the client, can retrieve information about the selected resource. The application 302 can generate a request to a specific URL which the server 304 responds to. This specific URL represents a resource location on the server 304 or a functionality which the server implements in a response for such request from the client. The server 304 can receive the request. At 310, the server 304 can return information related to the URL http://host/resource. For example, the server 304 can return the requested resource as a response to the client application that has sent the request. At 312, the client 302 can return information related to the URL http://host/resource. For example, the application 302 can return the information related to the selected URL that is received from the server 304.

In this example, the server 304 does not cause the client application (web browser) to locally store the received resource in its cache, for example, because the server 304 did not include instructions to do so in the response headers. At 314, the user 300 can click on a resource to get information for an nth time, for example, a second time. When the user 300 selects the selectable object representing the resource a second time, the actions performed at 308, 310, and 312 are repeated. In other words, at 316, the application 302 can retrieve information by triggering a URL (for example, http://host/resource). At 318, the server 304 can return information related to the URL http://host/resource. At 320, the client 302 can return information related to the URL http://host/resource.

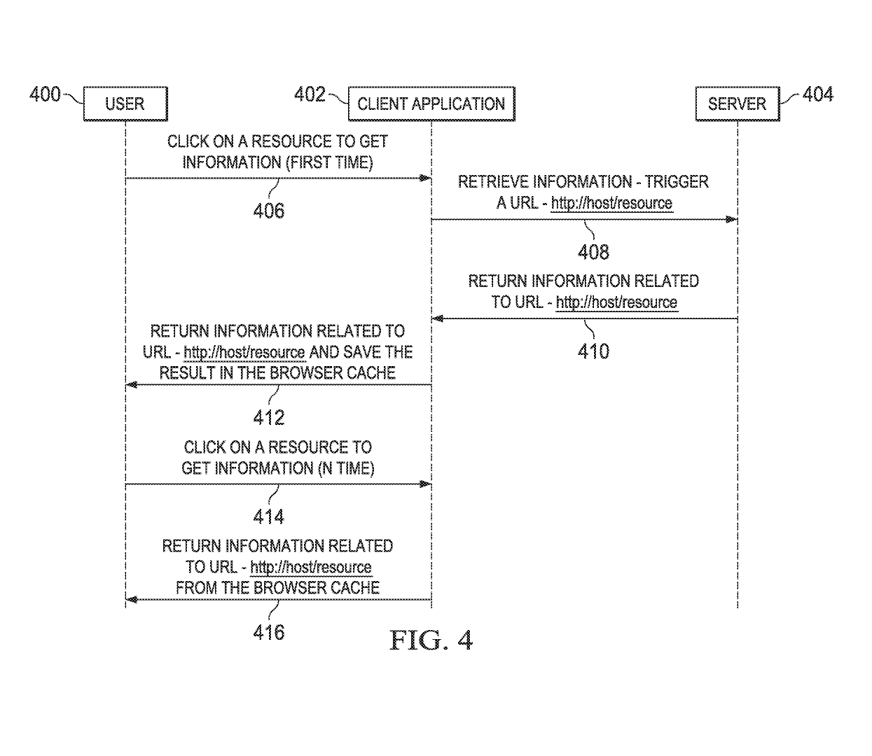

The aforementioned example results in an application transmitting a request for a resource to the server for each instance of selection of the object that the resource represents. The time taken to retrieve the remotely stored resource may impact a perceived performance of the application. As described below with reference to FIG. 4, the server can transmit a requested resource together with instructions to locally store the resource in the browser cache so that responses to future requests to the same resource can be retrieved from the locally stored cache rather than from the remotely stored resource.

FIG. 4 illustrates example operations in which a resource is locally stored for a duration. The actions performed in a first instance of a selection of a selectable object that represents a resource are similar to corresponding actions described above with reference to FIG. 3. For example, a user 400 can click on a resource to get information for a first time at 406. In response, the application 402 can retrieve information by triggering a URL (for example, http ://host/resource) at 408. The server 404 can receive the request, and, at 410, the server 404 can return information related to the URL http://host/resource. At 412, the client 402 can return information related to the URL http://host/resource.

In addition to returning the requested resource at 410, the server 404 can additionally instruct the web browser to locally store the resource in its cache. Thus, in addition to returning the information related to the selected URL at 412, the web browser also locally stores the resource in the cache. When the user 400 clicks on the resource to get information for an nth time, for example, a second time, at 414, the application 402 can trigger the same URL to the server, but since the response of that URL is already locally stored in the browser cache, the request will not reach the server 404 but rather will be retrieved from the browser cache and returned to the web application. In other words, the application 402 retrieves the locally stored information including the requested resource from the cache and returns the information. The application is not aware of the source of the response, i.e. whether it originated from the server or from the browser cache.

In the situation described with reference to FIG. 4, when a user of the application requests resource, a version of which has previously been received and locally stored, from the application, the web browser can retrieve and provide the locally stored resource to the application rather than transmit a new request for the remotely stored resource to the server. Because retrieving a response that is locally stored in the browser cache is much faster than transmitting a request to the server, the application will receive the locally stored resource faster than if the browser transmitted a new request to the server and received remotely stored resource from the server through the network. Consequently, the user of the application will perceive that a response time from when the user requested the resource to when the application presented the resource is short when the locally stored resource is retrieved relative to the response time when the remotely stored resource is requested and retrieved.

Versions of resources stored on a server may be updated, for example, by a provider of the resource. In the example of an Internet webpage of a news website, the webpages may be periodically updated to reflect the latest news. Thus, in some situations, after the server has transmitted a version of the remotely stored resource to the client with instructions to locally store the version, a provider of the resource may have modified the version of the remotely stored resource. Consequently, a current version of the remotely stored resource may not match a previous version of the locally stored resource. To address such scenarios, the server 404 can specify a duration for which the locally stored resource can be provided in the instructions to locally store the resource. For example, when the server 404 generates a response to the request received at 408, the server 404 can include instructions to locally store the resource and specify that the resource will remain valid for 10 days. When the user 404 interacts with the client application 402 in order to retrieve the resource at 414, the client application triggers a request for that resource which is then retrieved by the web browser from the local cache. The web browser checks if the duration of the locally stored resource has expired. If not, then the client application 402 can be provided with the locally stored resource. If yes, then the web browser can transmit a request for the resource to the server 404, in response to which the server 404 can provide a recent version of the resource. By performing the actions described with reference to FIG. 4, the perceived performance of the application 402 can be enhanced while ensuring that most recent versions of requested resources are periodically obtained from the server 404.

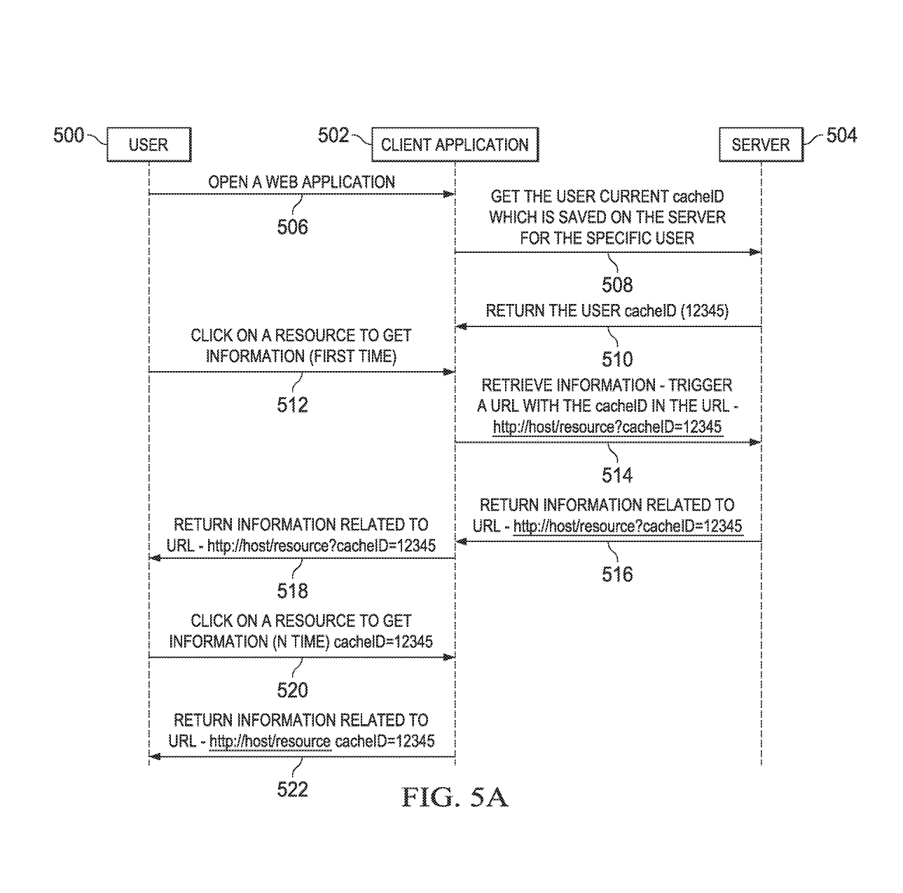

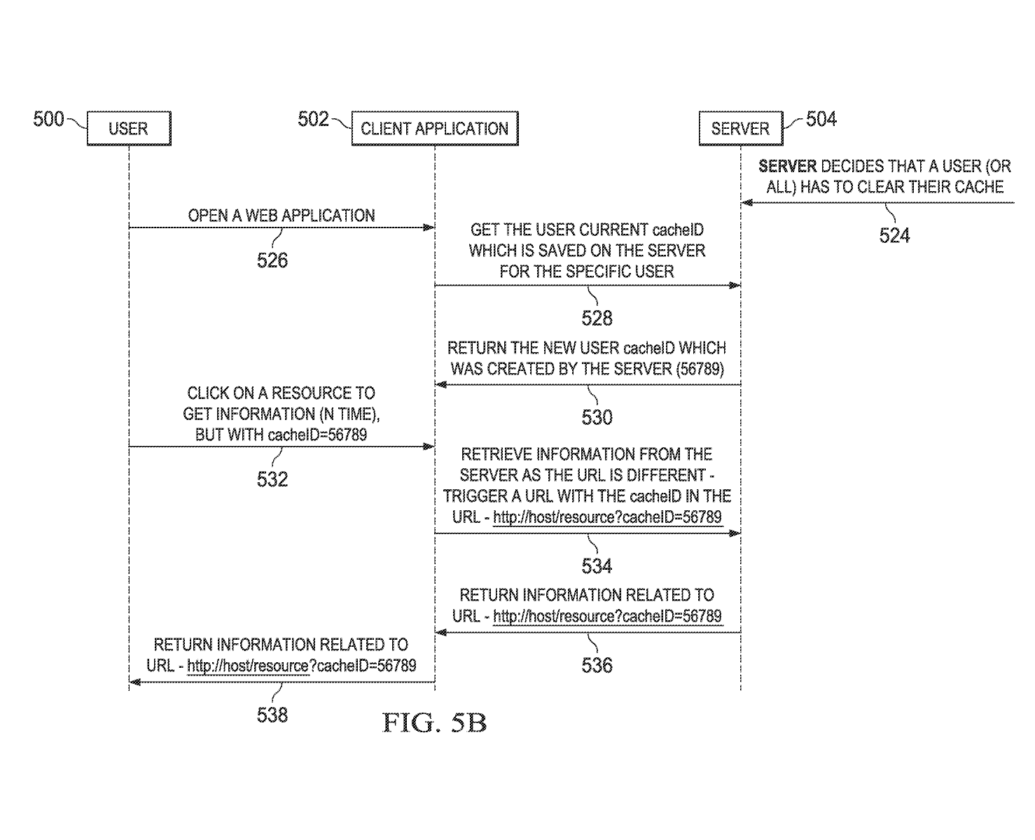

In some implementations described below with reference to FIGS. 5A and 5B, the server can transmit instructions to the application to invalidate locally stored versions of resources, for example, prior to expirations of the durations for which the server had previously specified that the resources would be valid. When the application 202 receives such instructions from the server, the application can receive remotely stored versions of the resources from the server instead of locally stored versions of the resources from the client. To transmit instructions to invalidate locally stored versions of resources, the server can implement a client identifier that uniquely identifies a client that executes the application, as described below.

FIGS. 5A and 5B illustrate example operations in which a locally stored resource is invalidated in response to instructions from a server. As shown in FIG. 5A, at 506, a user 500 can open a web application. For example, the user can launch a client application 502 that is executed by the web browser by entering the web application address (URL) in the browser address bar.

The server 504 returns the cacheID (for example, a client identifier such as “12345”) at 510 for the specific user 500, for example, as part of the initial data that the server returns to the client application when the application is launched, The server may store and maintain the cacheID in a database or its file system or any other type of server storage. When the server needs to return the cacheID to the client application, it retrieves the cacheID which is associated with user 500 of the client application from the server storage If the server 504 determines that no cacheID is associated with user 500, then the server 504 can generate a new cacheID for the user 500. The cacheID can be any unique value, for example, a random number such as “12345.” The unique number may be a timestamp, a timestamp combined with a unique user ID value, a combination of system entropy and a user ID or a random number generator, or any other suitable unique value. The server 504 can maintain such chacheIDs at the level of any identity type including, for example, users, roles, groups, and the like.

Once the cacheID is available in the client application as in 510, the application may append the cacheID to any or all of the URLs of the static resources such as links and images or when the application explicitly requests resources/data from the server. In some implementations, the client application can append the cacheID to less than all the URLs, for example, to those URLs for which the client wants to implement for the techniques described here. For those URLs for which the client does not want to implement the techniques described here, the client may not append the cacheID to the URL, for example, URLs to resources that shouldn't be invalidated when the cacheID is changed in the server (as will be described below) or URLs to resources that should be expired when the server has initially defined so or URLs which tell the server to perform some action on the server rather than retrieve data.

At 512, the user 500 clicks on a resource to get information for a first time. As described above, the user 500 selects a resource, for example, a selectable object displayed in the user interface provided by the client application 502. The selection at 512 represents a first time that the user 500 is selecting the object. At 514, the client application 502 retrieves information, i.e., triggers a URL to the server 504 with the cacheID in the URL (http://host/resource?cacheID=12345).

The server 504 returns information related to the URL http://host/resource?cacheID=12345 at 516. In addition, the server 504 provides instructions to the web browser to locally store the resource in the response headers. In these instructions, the server 504 can specify a duration for which the locally stored resource is valid. The web browser receives the information in the response headers and locally stores that response for the URL http://host/resource?cacheID=12345 At 518, the client application 502 returns information related to URL http://host/resource?cacheID=12345, for example, it displays the resource to the user 500 in the user interfacein response to the request received at 512.

At 520, the user 500 clicks on a resource to get information for an nth time, the resource having the URL http://host/resource?cacheID=12345. For example, the user 500 selects the resource for a second time. The client application 502 sends a request to that URL, but the web browser identifies that the response for that URL is already locally stored in the browser cache, and it therefore returns the locally stored resource to the client application 502

FIG. 5B describes actions performed when the server 504 determines to replace locally stored resources with a current version of a remotely stored resource. At 524, the server 504 decides that one or more or all users have to ignore the responses that are locally stored in the browser cache and retrieve the new version of resource from the server. For example, the server 504 can determine to do so upon determining that a resource has been updated or in response to receiving an instruction to do so from a provider of the resource. In order to do that, the server 504 determines to replace all or at least a portion of the existing cacheIDs in the server storage with new identifiers. After that has been made by the server in 524, when the user 500 opens a web application at 526, the client application 502 gets the user new cacheID (for example, “56789”)which has been saved on the server 504 for the specific user at 528. The server 504 can generate the new cacheID in 524, and return the new client identifier to the client application 502 at 528 as part of the initial data that the server returns to the client application when the application is launched. As before, the client application 502 can append the new cacheID to URLs of some or all resources that the client application 502 provides for user selection.

At 532, the user 500 clicks on a resource to get information for the nth time. The URL has the new cacheID, i.e., 56789. The user 500 can select the resource which the user 500 had previously selected. The URL to which the new cacheID “56789” has been appended is changed relative to the URL of the selections at 512 and 520. Because the new cacheID is unique, this ensures that the new URL of the resource selected at 530 hasn't been used before and, therefore, no response is locally stored in the browser cache for that URL.,When the client application triggers a request to the URL http://host/resource?cacheID=56789, the web browser transmits a request to the server 504 for the resource rather than retrieving the old version of the resource from the browser cache.

In similar manner, the application 502 has appended all the appropriate URLs of all resources provided with the new cacheID and consequently rendered all the URLs unique relative to past selections. Therefore, a selection of any of the URLs will result in a new request being transmitted to the server 504 rather than retrieval of a corresponding locally stored resource. In this manner, the server 504 can re-direct requests for resources received by the client application 502 to itself rather than the local cache. By doing so, the server 504 can invalidate the resources stored in the local cache without deleting the locally stored previous versions.

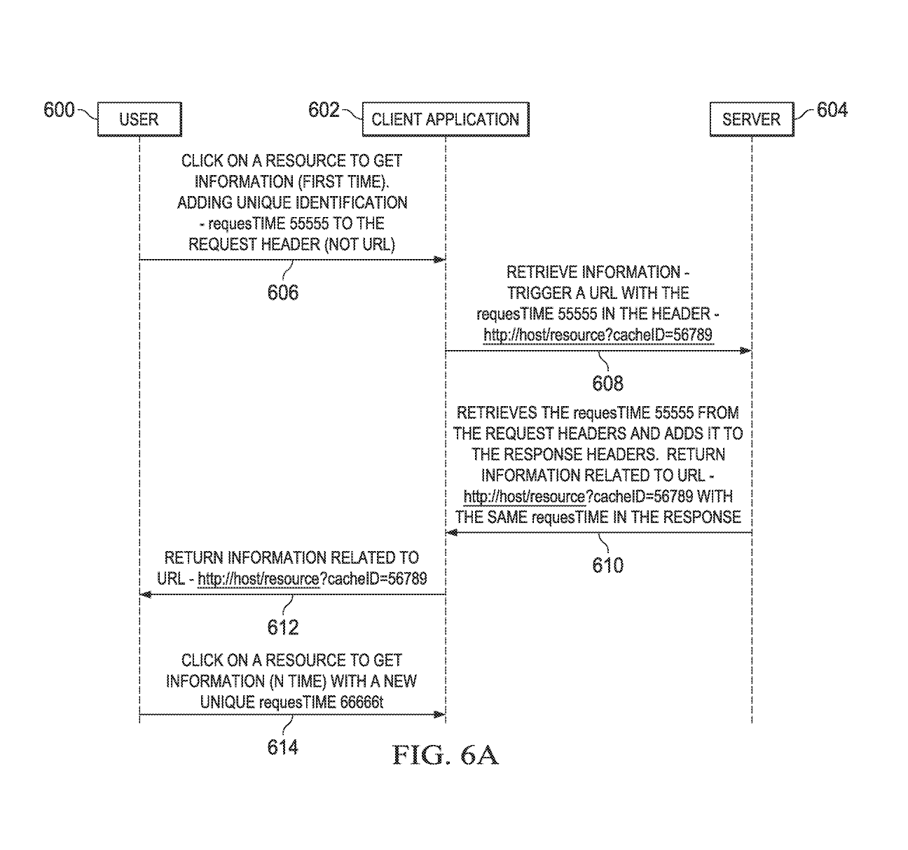

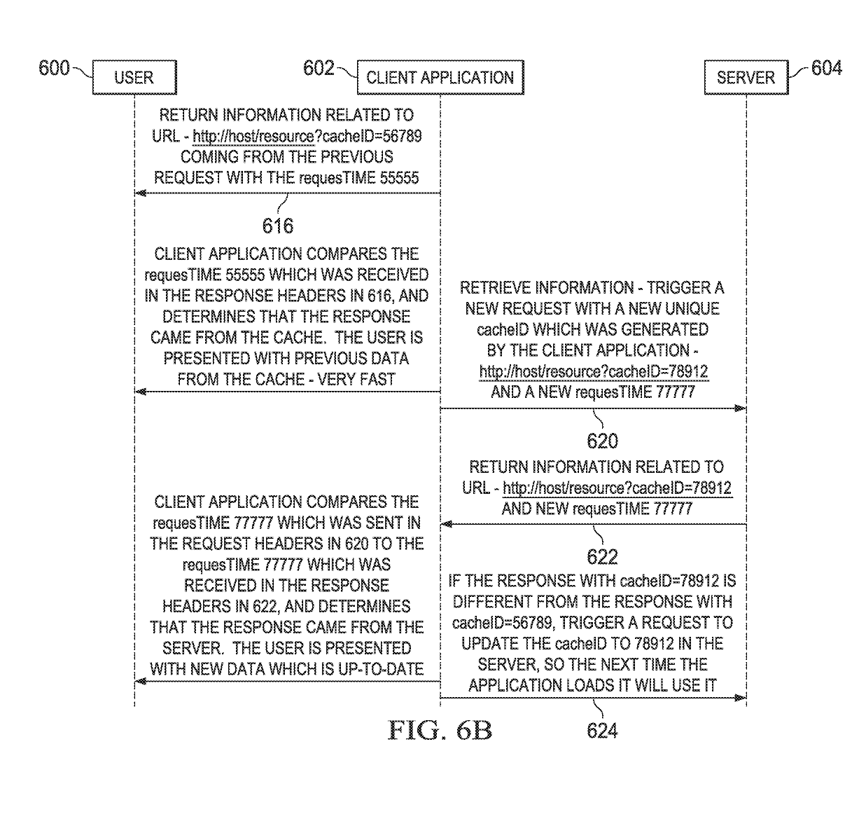

FIGS. 6A and 6B illustrate example operations in which a determination of whether a resource was retrieved locally or remotely is made. As shown in FIG. 6A, at 606, a user 600 clicks on a resource to get information for a first time. When the user 600 selects the resource, for example, by selecting the object that represents the resource, in addition to the cacheID that the application adds to the URL or the resource, the application 502 can add a unique request time identifier, which should be an identifier that is unique to the request sent at 608. For example, the request identifier can be a requestTime (for example, a timestamp), i.e., the time at which the client application 602 sends the request to the server. The application 602 can add the requestTime identifier to the request header, but not to the URL.

At 608, the application 602 retrieves information by triggering a URL http://host/resource?cacheID=56789 with the requestTime identifier in the header of the request

The server 604 recieves a request from the application 602 related to the URL http://host/resource?cacheID=56789.The server 604 can retrieve the requestTime identifier from the request header. The server 604 can generate a response to the request, and, in the response, include the resource referenced by the URL and the requestTime identifier that it got in the request. The server 604 can return the response to the application 602. The response can include instructions to locally store the resource. Upon receiving the instructions, the web browser can store the resource in the local cache. The application 602 returns information related to the URL http://host/resource?cacheID=56789 at 612.

At 614, the user 600 clicks on the resource to get information for the nth time. Because the time at which the user 600 clicked on the resource at 614 is different from the time at which the user 600 clicked on the resource at 606, the requestTime identifier responsive to the clicking at 614 is different from the requestTime identifier responsive to the clicking at 606. For example, the time stamp associated with the request at 606 is different from the time stamp associated with the request at 614.

As shown in FIG. 6B, at 616, the application 602 can return information related to the URL http://host/resource?cacheID=56789 and display that resource to the user in the user interface. At 616, the web browser returns the response that was stored in the local cache at 612. The locally stored response includes the requested resource and the requestTime identifier from the previous request. Because the application 602 received the response from the local cache and presented it to the user 600, the response time between when the user provided the request and when the user received the response is short. Consequently, the user 600 perceives an enhanced performance of the application 602.

Upon retrieving the information from the local cache, the client application 602 compares the requestTime identifier in the header of the response with the requestTime identifier that was included in the header of the request. If the response is received from the server 604, then the requestTime identifier in the request that the application 602 sent will match the request identifier that the application 602 received. In contrast, because the response is received from the local cache, the request identifier in the received response (which was from a previous request) does not match the request identifier in the request sent at 620. As a result, the application 602 performs the following actions to obtain a most recent version of the resource that is remotely stored on the server 604.

At 620, the application 602 retrieves information by triggering a new request with a new unique cacheID which the application 602 generates—http://host/resource?cacheID=78912. The application 602 can generate a new client identifier, for example, 78912, and append the new client identifier to the URL that references the resource that the client received at 620. For example, the application 602 replaces the previous cacheID in the URL with the new cacheID resulting in http://host/resource?cacheID=78912. At 622, the server 604 returns information related to URL http://host/resource?cacheID=78912. At 624, the application 602 determines if the response with cacheID=78912 is different from the response with cacheID=56789. If yes, then the application 602 triggers a request to update the cacheID to 78912 in the server 604 so that the next time the application 602 is loaded, the cacheID 78912 will be used.

If the application 602 determines that the received version of the resource is different from the past version that has been presented, then the application 602 can update the resource presented to the user 600. For example, as the user is interacting with the locally stored versions of the data, a remotely stored current version of the data can be received from the server, and the presented version of the data can be automatically updated based on differences, if any, between the locally stored and remotely stored versions. In addition, in some situations, the user can be notified that the version presented is a previous version and that a request has been transmitted for the current version so that the user is aware that an updated version of the data will be presented. Moreover, the updating can be dynamic in that it can be performed in substantially real-time, i.e., as soon as the updated version is received and without additional user selection or other input.

Thus, while implementing the techniques described here, a client application transmits a first request for a resource that is received at a web browser executing the client application. The client application provides a version of the resource received in response to transmitting the first request. A first version of the resource is remotely stored on a server computer system that is connected to the client computer system over a network. The server computer system is located remotely from the client computer system. A second version of the resource previously is locally stored on a computer-readable storage medium that is connected to and is local to the client computer system from which the first request is transmitted. The client application determines that the version of the resource that was provided was the second version of the resource locally stored on the computer-readable storage medium. In response to determining that the version of the resource that was provided was the second version, the client application transmits a second request to the server system to identify differences between the first version and the second version, in response to determining that the version of the resource that was provided was the second version.

The techniques described here can be implemented in several computer software applications. For example, in applications that display hierarchical or flat list of items (such as, for example, categories, topics, and the like), the application can “lazy load” content items, i.e., retrieve content items only when a user of the application selects the content items by activating a user interface operation which will trigger a request to the server. In such examples, if the user wishes to view the content item which has previously been viewed, the locally stored content item can be retrieved from cache resulting in a fast response to the user's request. The client can determine that the locally stored version of the resource has been displayed, and can transmit another request to the server for the remotely stored current version of the content item. If the remotely stored current version of the content item is different from the locally stored and previously presented version of the content item, then the client can update the presented version with the current version. This technique can be implemented for a content item associated with each item in the list, resulting in both enhanced perceived performance and presentation of current versions of content items.

In another example, applications implemented as dashboards or Internet web pages that display modules (or both) can implement the techniques described here such that when a page of the application loads, the application can display the locally stored list that was displayed the last time that the user visited the page and that was locally stored. Then, the application can receive a remotely stored updated list from the server, and updated the displayed list based on differences between the locally stored and remotely stored lists. To update the lists, the application can add or remove (or both) only relevant portions of the lists without reloading the entire page. This technique can improve the perceived performance of page loading and display current content of the page.

In a further example, the applications can be implemented as mobile device/tablet computer Internet applications that can have a fast perceived performance and the capability to work offline. When the user is online, i.e., when the user's mobile device is connected to the network, the resources of the application can be locally stored in a cache in the mobile device. This can enable the user to view the resources when offline. When the user returns online, the application can first present the cached resources, providing an enhanced perceived performance to the user, while the application obtains the remotely stored current version and updates the presented resources. In this manner, the user can view the resources in both offline and online modes of the mobile device.

In yet another example, the techniques described here can be implemented in Internet browser applications that apply Hypertext Markup Language (HTML) standards. The aspect of sending a second request for a remotely stored current version when a locally stored previous version of a resource is presented can be included as part of the HTML standards and implemented by various Internet browsers. In such implementations, the browser will already know whether a version that was presented in response to a request was a locally stored previous version or a remotely stored current version, thereby simplifying the application. To implement the techniques described here, after sending a request to the server—either as an ajax request (a background operation) or in response to a user selecting a URL in a user interface (like the <a> tag) or when content is loaded from the server (such as, <img> or <iframe> tags)—the browsers can determine if the response came from cache. If yes, then the browser can send the request again to the server to receive a current version. To do so, the browser can refer to options of the ajax request and the tag properties. The options can include an attribute which indicates whether to check for current version of the resource if the response comes from the cache, a function that can handle the response from the cache that includes a locally stored previous version of the resource, and a function that can handle the response the server which includes the remotely stored current version of the resource.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus, such as, for example, data processing apparatus 110, data processing apparatus 114. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium, such as, for example, computer-readable medium 112, computer-readable medium 116, can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical and/or non-transitory components or media (e.g., multiple CDs, disks, or other storage devices).

The operations described in this specification can be implemented as operations performed by a data processing apparatus on resource stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method performed by data processing apparatus, the method comprising:
transmitting a first request for a resource received at a client computer system;
providing a version of the resource received in response to transmitting the first request, wherein a first version of the resource is remotely stored on a server computer system that is connected to the client computer system over a network, the server computer system located remotely from the client computer system, and a second version of the resource is locally stored on a computer-readable storage medium that is connected to and is local to the client computer system from which the first request is transmitted;
determining that the version of the resource that was provided was the second version of the resource locally stored on the computer-readable storage medium; and
transmitting a second request to the server system to identify differences between the first version and the second version, in response to determining that the version of the resource that was provided was the second version.

2. The method of claim 1, wherein transmitting the first request further comprises:
including a first identifier in the first request; and
transmitting the first identifier with the first request to the server computer system.

3. The method of claim 2, wherein including the first identifier in the first request comprises including the first identifier in a header of the first request.

4. The method of claim 2, further comprising:
receiving a response from the server computer system in response to transmitting the first request, wherein the server computer system includes a second identifier in the response;
retrieving the second identifier; and
comparing the second identifier with the first identifier.

5. The method of claim 4, further comprising determining that the version of the resource that was provided was the second version based on determining that the first identifier does not match the second identifier.

6. The method of claim 5, wherein transmitting the second request to the server system to identify the differences between the first version and the second version comprises:
including a new identifier in the second request, wherein the server system includes the new identifier in a new response to the second request, the new response including the first version of the resource;
receiving the new response from the server computer system; and
determining that the new identifier included in the second request matches the new identifier in the new response.

7. The method of claim 6, wherein including the new identifier in the second request comprises appending the new identifier to a Uniform Resource Locator (URL) included in the second request, wherein the URL refers to the version of the resource.

8. The method of claim 6, further comprising:
comparing the first version of the resource and the second version of the resource; and
updating the provided version of the resource based on the differences, in response to determining that differences exist between the first version of the resource and the second version of the resource.

9. The method of claim 4, further comprising:
determining that the version of the resource that was provided was the first version based on determining that the first identifier matches the second identifier; and
not transmitting the second request to the server computer system in response to determining that the first identifier matches the second identifier.

10. The method of claim 2, further comprising:
generating the first identifier in response to receiving the first request; and
including the first identifier in the first request.

11. The method of claim 10, wherein the first identifier is a timestamp at which the first request was received.

12. The method of claim 1 further comprising invalidating the second version of the resource locally stored on the computer-readable storage medium in response to receiving an instruction from the server computer system to invalidate the second version.

13. The method of claim 12, wherein receiving the instruction from the server computer system to invalidate the second version comprises causing requests for the version of the resource to be transmitted to the server computer system instead of client computer system.

14. The method of claim 1, wherein the second version of the resource is locally stored on the computer-readable storage medium at a time prior to the first request for the resource being transmitted.

15. The method of claim 1, wherein the first version is a current version of the resource and the second version is a previous version of the resource previously received from the server computer system.

16. The method of claim 1, wherein transmitting the first request for resource comprises transmitting the first request for resource to the server computer system.

17. A non-transitory computer-readable medium tangibly encoding computer program instructions executable by data processing apparatus to perform operations comprising:
transmitting a first request for a resource received at a client computer system;
providing a version of the resource received in response to transmitting the first request, wherein a first version of the resource is remotely stored on a server computer system that is connected to the client computer system over a network, the server computer system located remotely from the client computer system, and a second version of the resource is locally stored on a computer-readable storage medium that is connected to and is local to the client computer system from which the first request is transmitted;
determining that the version of the resource that was provided was the second version of the resource locally stored on the computer-readable storage medium; and
transmitting a second request to the server system to identify differences between the first version and the second version, in response to determining that the version of the resource that was provided was the second version.

18. The medium of claim 17, wherein transmitting the first request further comprises:
including a first identifier in the first request; and
transmitting the first identifier with the first request to the server computer system.

19. The medium of claim 18, wherein including the first identifier in the first request comprises including the first identifier in a header of the first request.

20. The medium of claim 18, the operations further comprising:
receiving a response from the server computer system in response to transmitting the first request, wherein the server computer system includes a second identifier in the response;
retrieving the second identifier; and
comparing the second identifier with the first identifier.

21. The medium of claim 20, further comprising determining that the version of the resource that was provided was the second version based on determining that the first identifier does not match the second identifier.

22. The medium of claim 21, wherein transmitting the second request to the server system to identify the differences between the first version and the second version comprises:
including a new identifier in the second request, wherein the server system includes the new identifier in a new response to the second request, the new response including the first version of the resource;
receiving the new response from the server computer system; and
determining that the new identifier included in the second request matches the new identifier in the new response.

23. The medium of claim 22, wherein including the new identifier in the second request comprises appending the new identifier to a Uniform Resource Locator (URL) included in the second request, wherein the URL refers to the version of the resource.

24. The medium of claim 22, the operations further comprising:
comparing the first version of the resource and the second version of the resource; and
updating the provided version of the resource based on the differences, in response to determining that differences exist between the first version of the resource and the second version of the resource.

25. The medium of claim 20, the operations further comprising:
determining that the version of the resource that was provided was the first version based on determining that the first identifier matches the second identifier; and
not transmitting the second request to the server computer system in response to determining that the first identifier matches the second identifier.

26. The medium of claim 18, the operations further comprising:
generating the first identifier in response to receiving the first request; and
including the first identifier in the first request.

27. The medium of claim 26, wherein the first identifier is a timestamp at which the first request was received.

28. The medium of claim 17, the operations further comprising invalidating the second version of the resource locally stored on the computer-readable storage medium in response to receiving an instruction from the server computer system to invalidate the second version.

29. The medium of claim 28, wherein receiving the instruction from the server computer system to invalidate the second version comprises causing requests for the version of the resource to be transmitted to the server computer system instead of client computer system.

30. The medium of claim 17, wherein the second version of the resource is locally stored on the computer-readable storage medium at a time prior to the first request for the resource being transmitted.

31. The medium of claim 17, wherein the first version is a current version of the resource and the second version is a previous version of the resource previously received from the server computer system.

32. The medium of claim 17, wherein transmitting the first request for resource comprises transmitting the first request for resource to the server computer system.

33. A system comprising:
data processing apparatus; and
a non-transitory computer-readable medium tangibly encoding computer program instructions executable by the data processing apparatus to perform operations comprising:
transmitting a first request for a resource received at a client computer system;
providing a version of the resource received in response to transmitting the first request, wherein a first version of the resource is remotely stored on a server computer system that is connected to the client computer system over a network, the server computer system located remotely from the client computer system, and a second version of the resource is locally stored on a computer-readable storage medium that is connected to and is local to the client computer system from which the first request is transmitted;
determining that the version of the resource that was provided was the second version of the resource locally stored on the computer-readable storage medium; and
transmitting a second request to the server system to identify differences between the first version and the second version, in response to determining that the version of the resource that was provided was the second version.

34. The system of claim 33, wherein transmitting the first request further comprises:
including a first identifier in the first request; and
transmitting the first identifier with the first request to the server computer system.

35. The system of claim 34, wherein including the first identifier in the first request comprises including the first identifier in a header of the first request.

36. The system of claim 34, the operations further comprising:
receiving a response from the server computer system in response to transmitting the first request, wherein the server computer system includes a second identifier in the response;
retrieving the second identifier; and
comparing the second identifier with the first identifier.

37. The system of claim 36, further comprising determining that the version of the resource that was provided was the second version based on determining that the first identifier does not match the second identifier.

38. The system of claim 37, wherein transmitting the second request to the server system to identify the differences between the first version and the second version comprises:
including a new identifier in the second request, wherein the server system includes the new identifier in a new response to the second request, the new response including the first version of the resource;
receiving the new response from the server computer system; and
determining that the new identifier included in the second request matches the new identifier in the new response.

39. The system of claim 38, wherein including the new identifier in the second request comprises appending the new identifier to a Uniform Resource Locator (URL) included in the second request, wherein the URL refers to the version of the resource.

40. The system of claim 38, the operations further comprising:
comparing the first version of the resource and the second version of the resource; and
updating the provided version of the resource based on the differences, in response to determining that differences exist between the first version of the resource and the second version of the resource.

41. The system of claim 36, the operations further comprising:
determining that the version of the resource that was provided was the first version based on determining that the first identifier matches the second identifier; and
not transmitting the second request to the server computer system in response to determining that the first identifier matches the second identifier.

42. The system of claim 34, the operations further comprising:
generating the first identifier in response to receiving the first request; and
including the first identifier in the first request.

43. The system of claim 42, wherein the first identifier is a timestamp at which the first request was received.

44. The system of claim 33, the operations further comprising invalidating the second version of the resource locally stored on the computer-readable storage medium in response to receiving an instruction from the server computer system to invalidate the second version.

45. The system of claim 44, wherein receiving the instruction from the server computer system to invalidate the second version comprises causing requests for the version of the resource to be transmitted to the server computer system instead of client computer system.

46. The system of claim 33, wherein the second version of the resource is locally stored on the computer-readable storage medium at a time prior to the first request for the resource being transmitted.

47. The system of claim 33, wherein the first version is a current version of the resource and the second version is a previous version of the resource previously received from the server computer system.

48. The system of claim 33, wherein transmitting the first request for resource comprises transmitting the first request for resource to the server computer system.
